(19) United States
(12) Patent Application Publication
(10) Pub. No.: US 2018/0132499 A1
(43) Pub. Date: May 17, 2018

(54) FLOC SHORTENING SYSTEMS, METHODS OF MAKING, AND METHODS OF USE

(71) Applicant: Bunge Oils, Inc., St. Louis, MO (US)

(72) Inventor: Neil Wallace Higgins, Bourbonnais, IL (US)

(21) Appl. No.: 15/813,341

(22) Filed: Nov. 15, 2017

Related U.S. Application Data
(60) Provisional application No. 62/423,267, filed on Nov. 17, 2016.

(51) Int. Cl. A23D 9/013; C08L 91/00; A23L 33/26

(52) U.S. Cl. CPC A23D 9/013; A23V 2002/00; A23L 33/26; C08L 91/00

(57) ABSTRACT

The present invention relates to a shortening system that has reduced levels of saturated or trans fats. The shortening systems include an oil, a polyol, and finely divided particles that form a flocculent structure when combined. The present invention also includes methods of making and using the shortening systems, including applications in various food products.

### REFERENCE TO RELATED APPLICATIONS

This application claims the benefit of U.S. Provisional Patent Application Ser. No. 62/423,267, which was filed Nov. 17, 2016, and which is herein incorporated by reference in its entirety.

### FIELD

The invention generally relates to food ingredients and methods of manufacturing food ingredients. The invention specifically relates to reduced trans fat and reduced saturated fat replacement shortening systems for use as a food ingredient.

### BACKGROUND OF THE INVENTION

The consumption of saturated fats and trans fats can have negative impacts on the body. In humans, trans fats can increase the levels of low-density lipoproteins (LDL) and lower the levels of high-density lipoproteins (HDL); increase the risks of developing heart disease and stroke; and increase the risk of developing type 2 diabetes. Even small amounts of saturated or trans fats can be detrimental to health. The American Heart Association recommends reducing the intake of trans and saturated fats when possible.

A common dietary source of trans fats and saturated fats is shortenings, which are incorporated in many food products. Shortenings can be made from any fat, or combination of fats, that is solid at room temperature. Shortenings are used to make baked goods flaky or crumbly and are used in making or cooking many other food products. Shortenings are produced by a number of methods, including the thermal and mechanical treatment of a mixture of several components. The physical properties of the shortenings are governed by the organization of the crystal phase of the fats and the method of preparation. In addition, in order to ship shortening across distances, it is important that the shortening has an appropriate amount of structure to maintain the integrity of the shortening.

Different shortening compositions have been proposed for lowering the levels of trans fatty acids and saturated fatty acids in shortenings. U.S. Patent Publication 2005/0271790 and U.S. Pat. Nos. 5,106,644, 6,033,703, 5,470,598, 4,156,021, and 6,461,661 disclose exemplary shortening compositions. For example, Canadian Patent No. 2882572 A1 and U.S. Patent Application Publication 2015-0064329 relate to a bakery fat made of a lipid and a porous edible particle in a structured fat system where the lipid is present in a continuous phase. U.S. Pat. No. 5,306,516 discloses reduced fat shortenings comprising polyol fatty acid esters, a liquid nondigestible oil, and optionally, certain triglycerides or other polyol fatty acid polyesters. U.S. Pat. No. 8,394,445 discloses a shortening composition that incorporates cellulose fibers, which contain capillaries that reduce the levels of saturated and trans fats in the shortening compositions.

There is a continuing need for shortening systems with reduced levels of saturated or trans fats and with physical properties making them acceptable for food preparation. In addition, there is a need to maintain the integrity and structure of the shortening over a period of time and during shipment. There is also a need to produce shortening systems at a lower cost than similar existing systems, such as shortening compositions containing cellulose fibers, while achieving similar benefits (i.e., facilitating lower levels of saturated fatty acids in the shortening system).

### BRIEF SUMMARY OF THE INVENTION

Unless defined otherwise, all technical and scientific terms used herein have the same meaning as is commonly understood by one of ordinary skill in the art. All patents, applications, published applications and other publications are incorporated by reference in their entirety. In the event that there are a plurality of definitions for a term herein, those in this section prevail unless stated otherwise.

The present invention relates to a composition or article of manufacture, a method of using said composition or article of manufacture, or a process of manufacturing said composition or article of manufacture. In particular, at least one embodiment of the present invention relates to a floc shortening system comprising an oil, a polyol and a plurality of edible finely divided particles. The floc shortening system provides an alternative shortening system structure with reduced amounts of saturated or trans fatty acids.

Another embodiment relates to a process for making the subject floc shortening system.

Another embodiment relates to a process for using the subject floc shortening system to make food products.

Another embodiment relates to food products containing the subject floc shortening system of the present invention. Examples of such food products include baked goods, fillings, and microwave popcorn.

### DETAILED DESCRIPTION OF THE INVENTION

As used in the specification and the claims, the singular forms “a,” “an” and “the” include plural referents unless the context clearly dictates otherwise. Thus, for example, reference to “an oil” includes mixtures of two or more such oils, and the like.

All percent values are given as weight percent (% w/w) unless expressly stated otherwise.

Those skilled in the art will readily appreciate that the modes and details of the present invention can be changed in various ways without departing from the spirit and scope of the present invention. Thus, the present invention should not be construed as being limited to the description of the embodiments below.

### Definitions

### Polyol

The term “polyol” refers to a compound containing multiple hydroxyl groups. Polyols that are useful in the practice of the invention are edible and non-toxic. In one embodiment, the polyol is not ethylene glycol. In some embodiments, the polyol is simple polyol like glycerol (a.k.a. glycerin), a sugar alcohol, a synthetic polyol, or a natural oil polyol. In one embodiment, the polyol is a sugar alcohol. In some embodiments, the sugar alcohol is a 3-carbon sugar alcohol such as glycerol, a 4-carbon sugar alcohol such as erythritol or threitol, a 5-carbon sugar alcohol such as arabitol, xylitol, or ribitol, a 6-carbon sugar alcohol such as mannitol, sorbitol, galactitol, fucitol, iditol, or inositol, a 7-carbon sugar alcohol such as volemitol, a 12-carbon sugar alcohol such as isomalt, maltitol, or lactitol, an 18-carbon sugar alcohol such as maltotriitol, a 24-carbon sugar alcohol such as maltotetraitol, a sugar alcohol polymer such as polyglycitol, or the like.

In some embodiments, the polyol is a synthetic polyol such as a low molecular weight polyethylene glycol. In some embodiments, synthetic polyols can be polyethers or polyesters.

Without wishing to be bound by theory, the polyol is believed to serve a flocculator by forming a shell around the subject hydrophilic finely divided particle, thereby facilitating the formation of a flocculus, and to also associate with the lipophilic oil to facilitate the suspension and/or dispersion of the flocculi in the lipid phase. In some embodiments, the subject flocculus comprises another amphiphilic compound that is not a polyol or is employed in addition to a polyol, and in an amount that modulates the relative size of a flocculus without causing the collapse of the flocculus structure and/or the formation of a continuous emulsion. Examples of other useful amphiphilic compounds include, e.g., egg yolk lecithin, soy lecithin, Janus particles, silica, sodium stearoyl lactylate, emulsifying wax, ceteraryl alcohol, polysorbate 20 and other polysorbates, monoglycerides, and the like.

In one embodiment, the other amphiphilic compound is a lecithin compound at a concentration of less than 0.25% w/w, since 0.25% lecithin was observed to cause the floc to fail. In another embodiment, the other amphiphilic compound is a monoglyceride at a concentration of less than 0.7% w/w, since 0.7% monoglyceride was observed to cause the floc to fail. However, 0.25% monoglyceride was observed to facilitate the formation of smaller-sized and useful flocculi. Thus, in some embodiments, a monoglyceride is included in the floc shortening system to affect the size of the flocculi, thereby affecting the consistency, blending attributes, and downstream application utility of the floc shortening system. While not wishing to be bound by theory, the greater the amount of monoglyceride or other amphiphilic compound, the smaller the average size of the flocculi until a point at which the floc fails. In some embodiments, the floc shortening system contains monoglyceride in a by weight concentration of <0.7%, <0.6%, about 0.0001%-0.5%, about 0.01%, about 0.015%, about 0.02%, about 0.025%, about 0.03%, about 0.035%, about 0.04%, about 0.045%, about 0.05%, about 0.06%, about 0.07%, about 0.08%, about 0.09%, about 0.10%, about 0.15%, about 0.2%, about 0.25%, about 0.3%, about 0.35%, about 0.4%, about 0.45%, or about 0.5%.

As disclosed in the Examples below, an exemplar polyol used make the floc shortening systems is a 3-carbon sugar alcohol, i.e., glycerol. It must be understood, however, that other suitable polyols can and may be used in the subject floc shortening system, as described herein. For example, polyglycerol or other sugar alcohols can be used in the subject floc shortening system. In addition to the canonical food science polyols and polyol-containing emulsifiers, term “polyol” also includes sugars. Sucrose, for example, is a disaccharide containing multiple hydroxyl functional groups. Other polyolic sugars include e.g., glucose, fructose, galactose, lactose, maltose, isomaltose, cellobiose, trehalose, lactulose, chitobiose, mannobiose, and the like. In one embodiment, the polyol contains a concentrated sugar (e.g., sucrose) solution.

While not wishing to be bound by theory, the compound that serves as a polyol for the purpose of flocculating the finely divided particles is in a liquid form, such as liquid glycerol or solution of sugar or sugar alcohol (e.g., syrup) when combined with the solid phase finely divided particles. Conversely, a sugar or sugar alcohol in solid form may serve as the finely divided particles (powder), such as e.g., confectioners' sugar (see below).

### Finely Divided Particle

The term “finely divided particle” is used interchangeably with “fine particles” and refers to an edible particle with a length or hydrodynamic diameter of 100 microns or less. The length or diameter can be determined by any method known in the art, such as microscopy, dynamic light scattering, sieving, imaging particle analysis, and the like. Yan and Barbosa-Canovas, Food Science and Technology International, 3(5), Oct. 1, 1997 is incorporated by reference for methods of determining particle size in food powders. The term “plurality of finely divided particles,” which is used interchangeably with “powder” or “plurality of fine particles,” refers to a collection of finely divided particles with an average length or hydrodynamic diameter of 100 microns or less, a median length or hydrodynamic diameter of 100 microns or less, and/or a mode length or hydrodynamic diameter of 100 microns or less. For example, a method for making food grade finely divided particles comprising, e.g., cellulose is described in EP Pat. App. Pub. No. EP0153182A2.

In one embodiment, the length or diameter of the finely divided particle, or the mode, mean, or median length or diameter of the particles in the plurality of finely divided particles is <100 microns, <50 microns, several microns, several tens of microns, 0.01-100 microns, 0.01-50 microns, 1-50 microns, 1-20 microns, about 1 micron, about 2 microns, about 3 microns, about 4 microns, about 5 microns, about 6 microns, about 7 microns, about 8 microns, about 9 microns, about 10 microns, about 11 microns, about 12 microns, about 13 microns, about 14 microns, about 15 microns, about 16 microns, about 17 microns, about 18 microns, about 19 microns, about 20 microns, about 21 microns, about 22 microns, about 23 microns, about 24 microns, about 25 microns, about 26 microns, about 27 microns, about 28 microns, about 29 microns, about 30 microns, about 31 microns, about 32 microns, about 33 microns, about 34 microns, about 35 microns, about 36 microns, about 37 microns, about 38 microns, about 39 microns, about 40 microns, about 41 microns, about 42 microns, about 43 microns, about 44 microns, about 45 microns, about 46 microns, about 47 microns, about 48 microns, about 49 microns, about 50 microns, about 55 microns, about 60 microns, about 65 microns, about 70 microns, about 75 microns, about 80 microns, about 85 microns, about 90 microns, about 95 microns, or about 100 microns.

In one embodiment, the chemical nature of the finely divided particle is of a salt, such as e.g., sodium chloride or potassium chloride. In one embodiment the chemical nature of the finely divided particle is of a naturally occurring polymer, such as e.g., starch, glycogen, cellulose, gelatin, keratin, silk, rubber, lignin, melanin, suberin, chitin, chitosan, and the like. In one embodiment, the chemical nature of the finely divided particle is a monosaccharide, e.g., glucose or fructose, or a disaccharide, e.g., trehalose or sucrose, such as confectioners' (powdered) sugar.

In one embodiment, the powder is a food starch, modified starch, flour, salt, (e.g., sodium chloride ground to sufficient fineness) maltodextrin, sugar, or confectioners' (powdered) sugar. In one embodiment, the plurality of the finely divided particles comprises one or more of starch granules obtained from corn, pea, potato, wheat, rice, millet, barley, quinoa, soy, banana, or other starch from a fruit, grain or legume, finely milled rice, millet, barley, quinoa, soy, wheat or other grain or legume flours, cocoa powder, ground spices or other particulate flavoring agents, milk solids, yeast, and minerals (such as sodium, potassium, calcium, magnesium, and zinc), or combinations thereof. In preferred embodiments, the finely divided particles are starch granules, and a particularly preferred starch granule for use in the present invention is corn starch.

In one embodiment, the powder is a protein isolate, such as e.g., whey protein isolate, soy protein isolate, beef protein isolate, and the like.

### Lipid

The term “lipid” refers to monoglycerides, diglycerides, triglycerides (a.k.a. fats and oils), waxes, sterols, and phospholipids. The term “lipid phase” refers to the lipid-containing portion of a mixture, dispersion, or colloidal dispersion containing a solid or liquid lipid and a discontinuous substance, such as a flocculus containing a lipophobic particle. For example, in a mixture of flocculi and oil, the oil comprises the lipid phase. The lipid phase may represent any portion by weight of the entire mixture—from as little as e.g., 1% to as much as e.g., 99%.

The term “liquid oil” refers to a lipid which is substantially liquid at room temperature. The liquid oil can contain one or more lipids with one or more unhydrogenated fatty acid chains, partially hydrogenated fatty acid chains, fully hydrogenated fatty acid chains, modified lipids, or mixtures thereof. The term “oil” includes both “liquid oil” and “solid oil” which is solid at room temperature. The term “solid oil” is used interchangeably with the term “hard oil” or “hard fat” regardless of the source of the oil. Generally, the term “oil” is used to denote triglycerides or diglycerides (DAG) or monoglycerides obtained from plant sources, whereas the term “fat” is used to denote mono-, di-, and triglycerides obtained from animal sources. Notwithstanding this convention, the term “hard fat” may be used herein to refer to oil that is solid at room temperature, such as fully hydrogenated vegetable oil.

The term “saturated fat,” “saturated fatty acids,” “saturated oils,” and “fully hydrogenated oil” as used herein refer to C4 to C26 fatty acids or esters thereof containing no unsaturation (i.e., carbon-carbon double bonds) and containing only carbon-carbon single bonds.

The term “trans,” and “trans fatty acids” as used herein refer to fatty acids and/or esters containing double bonds in the trans configuration, generally resulting from the hydrogenation or partial hydrogenation of a fat or oil.

In a preferred embodiment, the subject lipid is a vegetable oil such as e.g., canola and other rapeseed oils, coconut oil, corn oil, cotton seed oil, olive oil, palm oil, peanut oil, safflower oil, sesame oil, soybean oil, sunflower seed oil, diacylglycerols (a.k.a. diglycerides or DAG), fully hydrogenated forms of canola and other rapeseed oils, coconut oil, corn oil, cotton seed oil, olive oil, palm oil, peanut oil, safflower oil, sesame oil, soybean oil, sunflower seed oil, palm oil, and the like.

In some embodiments, the subject oil contains one or more of the following fatty acids: C14, C15:1, C16, C16:1T, C17:1, C18, C18:1T, C18:1, C18:2T, C18:2, C20, C18:3T, C20:1, C18:3, C20:2, C22, C24, and C24:1. In some embodiments, the relative amount by weight of C14 fatty acids out of the total amount by weight of all fatty acids of the subject oil (% C14) is about 0.1%-0.2%, about 0.1%, about 0.11%, about 0.12%, about 0.13%, about 0.14%, about 0.15%, about 0.16%, about 0.17%, about 0.18%, about 0.19%, or about 0.2%.

In some embodiments, the relative amount by weight of C15:1 fatty acids out of the total fatty acids of the subject oil (% C15:1) is about 0%-0.01%, about 0.001%, about 0.002%, about 0.003%, about 0.004%, about 0.005%, about 0.006%, about 0.007%, about 0.008%, about 0.009%, about 0.01%, or about 0.011%.

In some embodiments, the relative amount by weight of C16 fatty acids out of the total fatty acids of the subject oil (% C16) is about 5%-15%, about 5%, about 6%, about 7%, about 8%, about 9%, about 10%, about 11%, about 12%, about 13%, about 14%, about 15%, or >15%.

In some embodiments, the relative amount by weight of C16:1T fatty acids out of the total fatty acids of the subject oil (% C16:1T) is about 0%-0.05%, about 0.001%, about 0.002%, about 0.003%, about 0.004%, about 0.005%, about 0.01%, about 0.015%, about 0.02%, about 0.025%, about 0.03%, about 0.035%, about 0.04%, about 0.045%, or about 0.05%.

In some embodiments, the relative amount by weight of C16:1 fatty acids out of the total fatty acids of the subject oil (% C16:1) is about 0%-0.5%, about 0.01%, about 0.02%, about 0.03%, about 0.04%, about 0.05%, about 0.1%, about 0.15%, about 0.2%, about 0.21%, about 0.22%, about 0.23%, about 0.24%, about 0.25%, about 0.26%, about 0.27%, about 0.28%, about 0.29%, about 0.3%, about 0.35%, about 0.4%, about 0.45%, or about 0.5%.

In some embodiments, the relative amount by weight of C17:1 fatty acids out of the total fatty acids of the subject oil (% C17:1) is about 0%-0.2%, about 0.05%-0.15%, about 0.01%, about 0.015%, about 0.025%, about 0.03%, about 0.035%, about 0.04%, about 0.045%, about 0.05%, about 0.055%, about 0.06%, about 0.065%, about 0.07%, about 0.075%, about 0.08%, about 0.085%, about 0.09%, about 0.091%, about 0.092%, about 0.093%, about 0.094%, about 0.095%, about 0.096%, about 0.097%, about 0.098%, about 0.099%, about 0.1%, about 0.11%, about 0.12%, about 0.13%, about 0.14%, about 0.15%, about 0.16%, about 0.17%, about 0.18%, about 0.19%, or about 0.2%.

In some embodiments, the relative amount by weight of C18 fatty acids out of the total fatty acids of the subject oil (% C18) is about 5%-15%, about 7%-10%, about 5%, about 6%, about 7%, about 7.1%, about 7.2%, about 7.3%, about 7.4%, about 7.5%, about 7.6%, about 7.7%, about 7.8%, about 7.9%, about 8%, about 8.1%, about 8.2%, about 8.3%, about 8.4%, about 8.5%, about 8.6%, about 8.7%, about 8.8%, about 8.9%, about 9%, about 9.1%, about 9.2%, about 9.3%, about 9.4%, about 9.5%, about 9.6%, about 9.7%, about 9.8%, about 9.9%, about 10%, about 11%, about 12%, about 13%, about 14%, or about 15%.

In some embodiments, the relative amount by weight of C18:1T fatty acids out of the total fatty acids of the subject oil (% C18:1T) is about 0%-0.2%, about 0.05%-0.15%, about 0.01%, about 0.015%, about 0.025%, about 0.03%, about 0.035%, about 0.04%, about 0.045%, about 0.05%, about 0.055%, about 0.06%, about 0.065%, about 0.07%, about 0.075%, about 0.08%, about 0.085%, about 0.09%, about 0.091%, about 0.092%, about 0.093%, about 0.094%, about 0.095%, about 0.096%, about 0.097%, about 0.098%, about 0.099%, about 0.1%, about 0.11%, about 0.12%, about 0.13%, about 0.14%, about 0.15%, about 0.16%, about 0.17%, about 0.18%, about 0.19%, or about 0.2%.

In some embodiments, the relative amount by weight of C18:1 fatty acids out of the total fatty acids of the subject oil (% C18:1) is about 30%-70%, about 40%-60%, about 45%-55%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, or about 70%.

In some embodiments, the relative amount by weight of C18:2T fatty acids out of the total fatty acids of the subject oil (% C18:2T) is about 0%-0.2%, about 0.05%-0.15%, about 0.01%, about 0.015%, about 0.025%, about 0.03%, about 0.035%, about 0.04%, about 0.045%, about 0.05%, about 0.055%, about 0.06%, about 0.065%, about 0.07%, about 0.075%, about 0.08%, about 0.085%, about 0.09%, about 0.091%, about 0.092%, about 0.093%, about 0.094%, about 0.095%, about 0.096%, about 0.097%, about 0.098%, about 0.099%, about 0.1%, about 0.11%, about 0.12%, about 0.13%, about 0.14%, about 0.15%, about 0.16%, about 0.17%, about 0.18%, about 0.19%, or about 0.2%.

In some embodiments, the relative amount by weight of C18:2 fatty acids out of the total fatty acids of the subject oil (% C18:2) is about 10%-20%, about 12%-18%, about 15%-17%, about 10%, about 10.5%, about 11%, about 11.5%, about 12%, about 12.5%, about 13%, about 13.5%, about 14%, about 14.5%, about 15%, about 15.5%, about 16%, about 16.1%, about 16.2%, about 16.3%, about 16.4%, about 16.5%, about 16.6%, about 16.7%, about 16.8%, about 16.9%, about 17%, about 17.5%, about 18%, about 18.5%, about 19%, about 19.5%, or about 20%.

In some embodiments, the relative amount by weight of C18:3T fatty acids out of the total fatty acids of the subject oil (% C18:3T) is about 0%-0.4%, about 0.01%-0.35%, about 0.01%, about 0.015%, about 0.025%, about 0.03%, about 0.035%, about 0.04%, about 0.045%, about 0.05%, about 0.055%, about 0.06%, about 0.065%, about 0.07%, about 0.075%, about 0.08%, about 0.085%, about 0.09%, about 0.091%, about 0.092%, about 0.093%, about 0.094%, about 0.095%, about 0.096%, about 0.097%, about 0.098%, about 0.099%, about 0.1%, about 0.11%, about 0.12%, about 0.13%, about 0.14%, about 0.15%, about 0.16%, about 0.17%, about 0.18%, about 0.19%, about 0.2%, about 0.21%, about 0.22%, about 0.23%, about 0.24%, about 0.25%, about 0.26%, about 0.27%, about 0.28%, about 0.29%, about 0.3%, about 0.31%, about 0.32%, about 0.33%, about 0.34%, about 0.35%, about 0.36%, about 0.37%, about 0.38%, about 0.39%, or about 0.42%.

In some embodiments, the relative amount by weight of C18:3 fatty acids out of the total fatty acids of the subject oil (% C18:3) is about 1%-15%, about 4%-10%, about 6%-8%, about 4%, about 4.5%, about 5%, about 5.5%, about 6.1%, about 6.2%, about 6.3%, about 6.4%, about 6.5%, about 6.6%, about 6.7%, about 6.8%, about 6.9%, about 7%, about 7.1%, about 7.2%, about 7.3%, about 7.4%, about 7.5%, about 7.6%, about 7.7%, about 7.8%, about 7.9%, about 8%, about 8.5%, about 9%, about 9.5%, about 10%, about 10.5%, about 11%, about 11.5%, about 12%, about 12.5%, 13%, about 13.5%, about 14%, about 14.5%, or about 15%.

In some embodiments, the relative amount by weight of C20 fatty acids out of the total fatty acids of the subject oil (% C20) is about 0.1%-1%, about 0.3%-0.8%, about 0.4%-0.7%, about 0.1%, about 0.15%, about 0.2%, about 0.25%, about 0.3%, about 0.35%, about 0.4%, about 0.45%, about 0.5%, about 0.55%, about 0.56%, about 0.57%, about 0.58%, about 0.59%, about 0.6%, about 0.61%, about 0.62%, about 0.63%, about 0.64%, about 0.65%, about 0.7%, about 0.75%, about 0.8%, about 0.85%, about 0.9%, about 0.95%, or about 1%.

In some embodiments, the relative amount by weight of C20:1 fatty acids out of the total fatty acids of the subject oil (% C20:1) is about 0.1%-5%, about 0.5%-4%, about 1%-2%, about 0.5%, about 1%, about 1.1%, about 1.2%, about 1.3%, about 1.4%, about 1.5%, about 1.6%, about 1.7%, about 1.8%, about 1.9%, about 2%, about 2.5%, about 3%, about 3.5%, about 4%, about 4.5%, or about 5%.

In some embodiments, the relative amount by weight of C20:2 fatty acids out of the total fatty acids of the subject oil (% C20:2) is about 0.01%-0.1%, about 0.01%, about 0.015%, about 0.02%, about 0.025%, about 0.03%, about 0.035%, about 0.04%, about 0.041%, about 0.042%, about 0.043%, about 0.044%, about 0.045%, about 0.046%, about 0.047%, about 0.048%, about 0.049%, about 0.05%, about 0.051%, about 0.052%, about 0.053%, about 0.054%, about 0.055%, about 0.056%, about 0.057%, about 0.058%, about 0.059%, about 0.06%, about 0.065%, about 0.07%, about 0.075%, about 0.08%, about 0.085%, about 0.09%, about 0.095%, or about 0.1%.

In some embodiments, the relative amount by weight of C22 fatty acids out of the total fatty acids of the subject oil (% C22) is about 0.1%-1%, about 0.3%-0.8%, about 0.4%-0.7%, about 0.1%, about 0.15%, about 0.2%, about 0.25%, about 0.3%, about 0.31%, about 0.32%, about 0.33%, about 0.34%, about 0.35%, about 0.36%, about 0.37%, about 0.38%, about 0.39%, about 0.4%, about 0.45%, about 0.5%, about 0.55%, about 0.6%, about 0.65%, about 0.7%, about 0.75%, about 0.8%, about 0.85%, about 0.9%, about 0.95%, or about 1%.

In some embodiments, the relative amount by weight of C24 fatty acids out of the total fatty acids of the subject oil (% C24) is about 0.01%-0.2%, about 0.05%-0.15%, about 0.05%, about 0.055%, about 0.06%, about 0.065%, about 0.07%, about 0.075%, about 0.08%, about 0.085%, about 0.09%, about 0.091%, about 0.092%, about 0.093%, about 0.094%, about 0.095%, about 0.096%, about 0.097%, about 0.098%, about 0.099%, about 0.1%, about 0.105%, about 0.11%, about 0.115%, about 0.12%, about 0.125%, about 0.13%, about 0.135%, about 0.14%, about 0.145%, about 0.15%, about 0.16%, about 0.17%, about 0.18%, about 0.19%, or about 0.2%.

In some embodiments, the relative amount by weight of C24:1 fatty acids out of the total fatty acids of the subject oil (% C24:1) is about 0.01%-0.2%, about 0.05%-0.15%, about 0.05%, about 0.055%, about 0.06%, about 0.065%, about 0.07%, about 0.075%, about 0.08%, about 0.085%, about 0.09%, about 0.091%, about 0.092%, about 0.093%, about 0.094%, about 0.095%, about 0.096%, about 0.097%, about 0.098%, about 0.099%, about 0.1%, about 0.105%, about 0.11%, about 0.115%, about 0.12%, about 0.125%, about 0.13%, about 0.135%, about 0.14%, about 0.145%, about 0.15%, about 0.16%, about 0.17%, about 0.18%, about 0.19%, or about 0.2%.

In some embodiments, the subject oil contains a percentage by weight of saturated fatty acids of the total weight of fatty acids of subject oil (“percent saturated fatty acids (w/w)” or “% Sat'd FA”) of about 15%-25%, about 16%-22%, about 17%-21%, about 15%, about 15.5%, about 16%, about 16.5%, about 17%, about 17.5%, about 18%, about 18.5%, about 19%, about 19.5%, about 20%, about 20.5%, about 21%, about 21.5%, about 22%, about 22.5%, about 23%, about 23.5%, about 24%, and 24.5%, or about 25%.

In some embodiments, the subject oil contains a percentage by weight of polyunsaturated fatty acids of the total weight of fatty acids of subject oil (“percent polyunsaturated fatty acids (w/w)” or “% PUFA”) of about 20%-30%, about 21%-26%, about 22%-25%, about 20%, about 20.5%, about 21%, about 21.5%, about 22%, about 22.5%, about 23%, about 23.5%, about 24%, about 24.5%, about 25%, about 25.5%, about 26%, about 26.5%, about 27%, about 27.5%, about 28%, about 28.5%, about 29%, and 29.5%, or about 30%.

In one embodiment, the subject oil does not contain trans fatty acids. In other embodiments, the subject oil contains less than one (1) percent by weight of trans fatty acids of the total weight of fatty acids of subject oil (“percent trans fatty acids (w/w)” or “% Trans”), about 0.001%-1%, about 0.0%-0.6%, about 0.001%, about 0.01%, about 0.1%, about 0.11%, about 0.12%, about 0.13%, about 0.14%, about 0.15%, about 0.16%, about 0.16%, about 0.18%, about 0.19%, about 0.2%, about 0.21%, about 0.22%, about 0.23%, about 0.24%, about 0.25%, about 0.26%, about 0.27%, about 0.28%, about 0.29%, about 0.30%, about 0.31%, about 0.32%, about 0.33%, about 0.34%, about 0.35%, about 0.36%, about 0.37%, about 0.38%, about 0.39%, about 0.40%, about 0.41%, about 0.42%, about 0.43%, about 0.44%, about 0.45%, about 0.46%, about 0.47%, about 0.48%, about 0.49%, about 0.50%, about 0.51%, about 0.52%, about 0.53%, about 0.54%, about 0.55%, about 0.56%, about 0.57%, about 0.58%, about 0.59%, about 0.60%, about 0.61%, about 0.62%, about 0.63%, about 0.64%, about 0.65%, about 0.66%, about 0.67%, about 0.68%, about 0.69%, about 0.70%, about 0.71%, about 0.72%, about 0.73%, about 0.74%, about 0.75%, about 0.76%, about 0.77%, about 0.78%, about 0.79%, about 0.80%, about 0.81%, about 0.82%, about 0.83%, about 0.84%, about 0.85%, about 0.86%, about 0.87%, about 0.88%, about 0.89%, about 0.9%, about 0.91%, about 0.92%, about 0.93%, about 0.94%, about 0.95%, about 0.96%, about 0.97%, about 0.98%, about 0.99%, or about 1%.

In one embodiment, the subject oil contains mostly monounsaturated fatty acids. In some embodiments, the subject oil contains more than fifty percent by weight (>50% (w/w)) of monounsaturated fatty acids of the total weight of fatty acids of subject oil (“percent monounsaturated fatty acids (w/w)” or “% Mono”), >30%, >35%, >40%, >45%, >55%, >60%, >65%, >70%, >75%, >80%, >85%, >90%, about 40%-99%, about 40%-80%, about 45%-55%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, or about 80%.

In some embodiments the subject oil contains one or more triglycerides with fatty acids with 12 (C12) to 24 (C24) or more carbons in length, irrespective of the degree of saturation. In one embodiment, the less than 1% each of the fatty acid chains are C14, C15, C17, C22, or C24. In one embodiment, about 10%±1.5% of the fatty acid chains are C16. In one embodiment, about 87%±5% of the fatty acid chains are C18. In one embodiment, about 2%±0.3% of the fatty acid chains are C20.

Floc

The term “floc” is used interchangeably with “flocculus (pl. flocculi)” or “flocculent structure” and refers to an aggregated mass of particles. A “floc” can form as a precipitate of particles suspended in a liquid, such as an oil. In one embodiment, the floc is an aggregate containing finely divided particles and a polyol suspended in an oil (liquid or hard) or otherwise associated with a lipid phase. In some embodiments, the average floc size (length or diameter) is about 0.1-5 mm, about 100 microns, about 200 microns, about 300 microns, about 400 microns, about 500 microns, about 600 microns, about 700 microns, about 800 microns, about 900 microns, about 1 mm, about 2 mm, about 3 mm, about 4 mm, or about 5 mm.

It has been found that the combination of a polyol with finely divided particles can give rise to a flocculent structure, or floc, which can entrap or contain oil, such as a vegetable oil, or mixture of oils. The floc is an aggregated mass of finely divided particles complexed with the polyol. It is believed that a floc formed between finely divided particles and a polyol can aid in structuring and/or stabilizing a shortening system, particularly as the oil solidifies or crystallizes concomitantly solidifying the shortening system.

### Particle-Polyol Ratio

In some embodiments, the finely divided particles (powder) and the polyol are combined in a weight-to-weight ratio of about 1:0.15 or lower to about 1:0.65 or higher. The ratio of powder to polyol is believed to depend in part on the size (i.e., length or diameter) of the particles. It is expected that smaller finely divided particles can have a broader acceptable range of ratios generating the desired floc structure. In these cases, the upper end of the preferred range can be greater than 1:0.65 or greater than 1:1, while the lower end of the preferred range can remain at 1:0.15 or lower. For example, it is expected that a floc structure can be generated with a ratio greater than 1:0.65 (i.e., 1:1 or greater) when the corn starch or other finely divided particles are substituted with other finely divided particles with smaller particles sizes (for example, rice starch has a smaller average particle size than corn starch). The optimal ratio for any combination of finely divided particles to polyol depends on the characteristics of the materials, such as the wetting ability of the solid particles, the size and porosity of the finely divided food-grade particles, and the polarity of the liquid used in making the floc shortening system, as well as the temperature at which the components are combined. Using the methods disclosed herein, a skilled artisan can determine the preferred range of ratios for generating floc structures from various powder:polyol combinations.

In one embodiment, the ratio by mass of finely divided particles (i.e., powder) to polyol is about 1:2 to about 1:0.01, about 1:2, about 1:1.9, about 1:1.8, about 1:1.7, about 1:1.6, about 1:1.5, about 1:1.4, about 1:1.3, about 1:1.2, about 1:1.1, about 1:1.0, about 1:0.95, about 1:0.9, about 1:0.85, about 1:0.8, about 1:0.75, about 1:0.7, about 1:0.65, about 1:0.6, about 1:0.55, about 1:0.5, about 1:0.45, about 1:0.4, about 1:0.35, about 1:0.3, about 1:0.25, about 1:0.2, about 1:0.15, about 1:0.1, about 1:0.09, about 1:0.08, about 1:0.07, about 1:0.06, about 1:0.05, about 1:0.04, about 1:0.03, about 1:0.02, or about 1:0.01.

### Manufacturing

The finely divided particles, which can occur naturally or as a product of milling or other manufacturing process, provide surfaces that a polyol in a liquid oil can wet the particles in a manner that results in the particles flocculating in the oil. That is, the particles form aggregated or compound masses that incorporate quantities of oil.

In one embodiment, a floc shortening system is made by combining oil, polyol, and fine particles, applying heat, and then allowing the mixture to sufficiently cool to permit crystallization of the oils. In one embodiment, the resultant oil-infused floc mass further processed to remove free oil to produce a concentrated floc shortening (a.k.a. “concentrated floc shortening”) with an acceptable consistency for storage and other downstream applications. As used herein, “free oil” refers to oil that is not trapped or otherwise sequestered by the flocculi (a.k.a. “unsequestered oil”). The free oil may be removed from the oil-infused floc mass by any means now known in the art or later developed. In one embodiment, the free oil is removed by centrifugation. In another embodiment, the free oil is removed by permitting the free-oil and the floc mass to separate under gravity (e.g., as in a separation funnel), and then decanting or removing the free oil. In yet another embodiment, the free oil is removed by filtering the oil-infused floc mass. In more particular embodiments, the free oil is removed from the oil-infused floc mass by vacuum filtration, rotary vacuum filtration, gravity filtration, belt filtration, or the like. Small scale batches of concentrated floc shortening can be made by filtering oil-infused floc mass over Whatman filter paper.

In one embodiment, the floc shortening system is manufactured by (a) combining one or more oils (including fully hydrogenated oils that are solid at room temperature), (b) heating the oil to an elevated temperature of about 40° C.-100° C., more preferably 60° C., (c) adding a polyol to the oil, (d) adding a finely divided particle (i.e., powder) to the oil/polyol mixture, and (e) cooling the oil/polyol/powder mixture to enable crystallization of the oil. In one embodiment, the oil/polyol/powder mixture is filtered before cooling completely to remove free oil to produce a floc shortening material with a desired consistency and oil content.

In one embodiment, the floc shortening system is manufactured by (a) combining the powder and polyol at an elevated temperature such as e.g., about 50° C.-70° C., more preferably 60°, to form a floc, (b) adding one or more oils (including fully hydrogenated oils that are solid at room temperature) to the powder/polyol floc at an elevated temperature, and (c) cooling the oil/polyol/powder mixture to enable crystallization of the oil. In one embodiment, the oil/polyol/powder mixture is filtered before cooling completely to remove free oil to produce a floc shortening material with a desired consistency and oil content.

In one embodiment, the size, uniformity, consistency, workability, and other attributes of the flocculi are controlled by modulating the pH of the floc system. In one embodiment, the pH of the floc system is lowered by adding an acid to the polyol solution, the polyol plus particles mixture, or the oil-polyol-particle mixture. In one embodiment, the acid is a food additive that is generally recognized as safe. In one embodiment, the acid is ascorbic acid, acetic acid, phosphoric acid, lactic acid, carbonic acid, or the like. While not wishing to be bound by theory, the change in pH is expected to influence the wetting of the particle surface to thereby modify e.g., the size, shape, and/or uniformity of the flocculi. The size, shape, and uniformity of the flocculi may be determined by way of a settling test or other methods, such as optical methods or the like.

Depending upon the desired attributes of the floc shortening system and the physicochemical nature of the starting ingredients, the oil and polyol and finely divided particles (powder) can be combined in various proportions. In some embodiments, the percent weight (% w/w) of oil present in the unconcentrated oil/polyol/powder mixture is about 40%-90%, about 50%-80%, about 55%-75%, about 60%-75%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, or about 90%. In a preferred embodiment, the oil is added to a final concentration in the unconcentrated oil/polyol/powder mixture at about 70%-75%, more preferably about 74%.

In some embodiments, the percent weight (% w/w) of the finely divided particles (a.k.a. powder) present in the unconcentrated oil/polyol/powder mixture is about 5%-45%, about 10%-40%, about 15%-35%, about 20%-30%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, or about 45%. In a preferred embodiment, the powder is added to a final concentration in the oil/polyol/powder mixture at about 15%-25%, more preferably about 30%.

In some embodiments, the percent weight (% w/w) of the polyol present in the unconcentrated oil/polyol/powder mixture is about 1%-15%, about 3%-9%, about 3%-12%, about 6%-9%, about 1%, about 2%, about 3%, about 4%, about 5%, about 6%, about 7%, about 8%, about 9%, about 10%, about 11%, about 12%, about 13%, about 14%, or about 15%. In a preferred embodiment, the polyol is added to a final concentration in the oil/polyol/powder mixture at about 3%-9%, more preferably about 6%.

In some embodiments, the oil/polyol/powder mixtures with various proportions of oil, powder, and polyol are depicted in Table 1.

TABLE 1
Oil/polyol/powder Mixtures

| Admixture | | Powder | Polyol |
|---|---|---|---|
| Number | Oil (% w/w) | (% w/w) | (% w/w) |
| 1 | 40.0 | 46.2 | 13.8 |
| 2 | 41.0 | 45.4 | 13.6 |
| 3 | 42.0 | 44.6 | 13.4 |
| 4 | 43.0 | 43.8 | 13.2 |
| 5 | 44.0 | 43.1 | 12.9 |
| 6 | 45.0 | 42.3 | 12.7 |
| 7 | 46.0 | 41.5 | 12.5 |
| 8 | 47.0 | 40.8 | 12.2 |
| 9 | 48.0 | 40.0 | 12.0 |
| 10 | 49.0 | 39.2 | 11.8 |
| 11 | 50.0 | 38.5 | 11.5 |
| 12 | 51.0 | 37.7 | 11.3 |
| 13 | 52.0 | 36.9 | 11.1 |
| 14 | 53.0 | 36.2 | 10.8 |
| 15 | 54.0 | 35.4 | 10.6 |
| 16 | 55.0 | 34.6 | 10.4 |
| 17 | 56.0 | 33.8 | 10.2 |
| 18 | 57.0 | 33.1 | 9.9 |
| 19 | 58.0 | 32.3 | 9.7 |
| 20 | 59.0 | 31.5 | 9.5 |
| 21 | 60.0 | 30.8 | 9.2 |
| 22 | 61.0 | 30.0 | 9.0 |
| 23 | 62.0 | 29.2 | 8.8 |
| 24 | 63.0 | 28.5 | 8.5 |
| 25 | 64.0 | 27.7 | 8.3 |
| 26 | 65.0 | 26.9 | 8.1 |
| 27 | 66.0 | 26.2 | 7.8 |
| 28 | 67.0 | 25.4 | 7.6 |
| 29 | 68.0 | 24.6 | 7.4 |
| 30 | 69.0 | 23.8 | 7.2 |
| 31 | 70.0 | 23.1 | 6.9 |
| 32 | 71.0 | 22.3 | 6.7 |
| 33 | 72.0 | 21.5 | 6.5 |
| 34 | 73.0 | 20.8 | 6.2 |
| 35 | 74.0 | 20.0 | 6.0 |
| 36 | 75.0 | 19.2 | 5.8 |
| 37 | 76.0 | 18.5 | 5.5 |
| 38 | 77.0 | 17.7 | 5.3 |
| 39 | 78.0 | 16.9 | 5.1 |
| 40 | 79.0 | 16.2 | 4.8 |
| 41 | 80.0 | 15.4 | 4.6 |
| 42 | 81.0 | 14.6 | 4.4 |
| 43 | 82.0 | 13.8 | 4.2 |
| 44 | 83.0 | 13.1 | 3.9 |
| 45 | 84.0 | 12.3 | 3.7 |
| 46 | 85.0 | 11.5 | 3.5 |
| 47 | 86.0 | 10.8 | 3.2 |
| 48 | 87.0 | 10.0 | 3.0 |
| 49 | 88.0 | 9.2 | 2.8 |
| 50 | 89.0 | 8.5 | 2.5 |
| 51 | 90.0 | 7.7 | 2.3 |

In some embodiments, the subject oil contains two or more different oils. In one embodiment, the subject oil contains an oil with <10% saturated fatty acid, and a fully hydrogenated oil. In a specific embodiment, the subject oil contains about 80%-95% of the <10% saturated fatty acid oil, and about 5%-20% of the fully hydrogenated oil. In one embodiment, the subject oil contains about 80%, about 81%, about 82%, about 83%, about 84%, about 85%, about 86%, about 87%, about 88%, about 89%, about 90%, about 91%, about 92%, about 93%, about 94%, or about 95% of the <10% saturated fatty acid oil, and about 5%, about 6%, about 7%, about 8%, about 9%, about 10%, about 11%, about 12%, about 13%, about 14%, about 15%, about 16%, about 17%, about 18%, about 19%, or about 20% of the fully hydrogenated oil. In a specific embodiment, the <10% saturated fatty acid oil is canola oil, and the fully hydrogenated oil is one or both of fully hydrogenated palm oil and fully hydrogenated soy oil. In a more specific embodiment, the subject oil contains about 86%-89% canola oil, about 8%-10% fully hydrogenated palm oil, and about 3%-4% hydrogenated soy oil.

In another embodiment, the subject oil contains an oil with <10% saturated fatty acid, and a diglyceride (DAG). In a specific embodiment, the subject oil contains about 70%-85% of the <10% saturated fatty acid oil, and about 15%-30% of the DAG. In one embodiment, the subject oil contains about 70%, about 71%, about 72%, about 73%, about 74%, about 75%, about 76%, about 77%, about 78%, about 79%, about 80%, about 81%, about 82%, about 83%, about 84%, or about 85% of the <10% saturated fatty acid oil, and about 15%, about 16%, about 17%, about 18%, about 19%, about 20%, about 21%, about 22%, about 23%, about 24%, about 25%, about 26%, about 27%, about 28%, about 29%, or about 30% of the DAG. In a specific embodiment, the <10% saturated fatty acid oil is canola oil. In a more specific embodiment, the subject oil contains about 75%-80% canola oil, and about 20%-25% DAG.

In some embodiments, the oil, the oil/polyol mixture, the polyol/powder mixture, and/or the oil/polyol/powder mixture is heated during manufacturing to an elevated temperature of about 40-100° C., about 50-80° C., about 50-70° C., about 40° C., about 41° C., about 42° C., about 43° C., about 44° C., about 45° C., about 46° C., about 47° C., about 48° C., about 49° C., about 50° C., about 51° C., about 52° C., about 53° C., about 54° C., about 55° C., about 56° C., about 57° C., about 58° C., about 59° C., about 60° C., about 61° C., about 62° C., about 63° C., about 64° C., about 65° C., about 66° C., about 67° C., about 68° C., about 69° C., about 70° C., about 71° C., about 72° C., about 73° C., about 74° C., about 75° C., about 76° C., about 77° C., about 78° C., about 79° C., about 80° C., about 81° C., about 82° C., about 83° C., about 84° C., about 85° C., about 86° C., about 87° C., about 88° C., about 89° C., about 90° C., about 91° C., about 92° C., about 93° C., about 94° C., about 95° C., about 96° C., about 97° C., about 98° C., about 99° C., or about 100° C. In a preferred embodiment, the oil, the oil/polyol mixture, the polyol/powder mixture, and/or the oil/polyol/powder mixture is heated to about 60° C. to enable the formation of flocculi.

The subject oil/polyol/powder floc mixture may be cooled down using one or more of a variety of protocols and devices. In one embodiment, the mixture is kept at room temperature and allowed to cool and crystalize over time. In another embodiment, the mixture is actively cooled such as by using e.g., an ice cream maker, and ice bath, an ice-water bath, a water bath, a refrigerator, a freezer, a heat exchanger, a scraped heat exchanger, or the like.

In one embodiment, the oil/polyol/powder mixture, either concentrated or unconcentrated, is cooled at room temperature. In another embodiment, the mixture is cooled at about 10° C.-40° C., about 4° C., about 5° C., about 6° C., about 7° C., about 8, about 9° C., about 10° C., about 11° C., about 12° C., about 13° C., about 14° C., about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., about 30° C., about 31° C., about 32° C., about 33° C., about 34° C., about 35° C., about 36° C., about 37° C., about 38° C., about 39° C., or about 40° C.

The flocs can trap oil and aid in structuring the shortening system as the floc plus oil mixture cools and the higher melting components of the shortening system crystallize. Examples of oil components that can be used individually or in combination to form a crystal network within the subject floc include fully hydrogenated oils, higher melting fractions of palm, cotton seed, or other oils with a high level of saturated fatty acids, natural or synthetic wax esters, solid emulsifiers such as mono or diacylglycerides, and/or solid polyglycerol esters.

In some embodiments, water-soluble particles such as e.g., sugar (e.g., sucrose) or salt (e.g., sodium chloride) can be incorporated as a component of some floc shortening systems. In those systems, the amount of water-soluble particles can be adjusted to modulate the size of the flocculi, level of lipidation of the flocculi, and overall appearance and performance of the floc shortening in its downstream application. For example, using salt in such a floc shortening system may be desired where shortening systems are used in more savory food, such as e.g., microwave popping corn.

The size and density of the finely divided particles were observed to affect the size of the floc structure that is generated in the subject floc shortening system. While not wishing to be bound by theory, the lower the bulk density and the smaller the particle size, the greater the amount of floc that is formed for any given weight of particles used. Furthermore, each type of finely divided solid particle will have a particular level of polyol that will form the best floc for sequestering oil and aiding in the structuring and ordering of the shortening system.

The choice of material for the finely divided particles may also affect the degree of lipidation of the flocculi and concomitantly the oil content of the final floc shortening product. For example, in a particular embodiment where the finely divided particles consist of corn starch and the polyol is glycerol, the filtered concentrated floc shortening with acceptable consistency contains about 50% oil. In another particular embodiment where the finely divided particles consist of white millet flour and the polyol is glycerol, the filtered concentrated floc shortening with acceptable consistency contains about 38% oil.

In one embodiment, the floc shortening having favorable consistency for storage and/or downstream application in food production contains oil by weight (% w/w) of about 30%-60%, about 35%-55%, about 37%-51%, about 25%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 65%, or about 70%.

It was further observed that some fine particles will not form a suitable floc with every polyol, and that some particle-polyol combinations may not yield a useable floc at all. For example, it was observed that wheat flour, which can be finely milled, did not produce significant floc with glycerol dispersed in vegetable oil.

In some of the Examples, the oil that was used included canola oil, fully hydrogenated palm oil, and fully hydrogenated soybean oil. Other suitable oils for use with the present invention include high oleic canola, soybean, corn, sunflower, rapeseed, peanut, safflower, olive, cottonseed, or mixtures thereof. In certain embodiments, the amount of oil in the unconcentrated (i.e., not concentrated) floc shortening system can be about 60-95% by weight based on the total weight of the floc shortening system. In certain embodiments, the amount oil in the unconcentrated floc shortening system is about 80-95% by weight based on the total weight of the floc shortening system.

In some specific embodiments, ratios ranging from 1:0.45 to 1:0.15 are preferred for the ratio between corn starch and glycerol (or between other finely divided particles and polyols). For some even more preferred embodiments, the 1:0.3 ratio is a preferred ratio for corn starch and glycerol (or other finely divided particles and polyols).

### Oil/Polyol/Powder Systems

In certain embodiments, the subject floc shortening contains oil, powder, and polyol in certain relative proportions. In some preferred embodiments, the unconcentrated floc shortening contains oil, polyol, and powder in proportions set forth e.g., in Table 1, wherein the concentration of oil is greater than about 60% w/w. In one embodiment, the ratio by weight of oil to powder to polyol (oil:powder:polyol) of the concentrated floc shortening is about 4-150 parts oil to about 1-15 parts powder to about 1 part polyol. In one embodiment, the oil:powder:polyol ratio of the concentrated floc shortening is about 4:1:1, about 86:40:3, about, about 6:1:1, about 129:40:3, about 8:1:1, about 172:40:3, about 10:1:1, about 215:40:30, about 12:1:1, about 258:40:3, about 14:1:1, about 301:40:3, about 16:1:1, 344:40:3, about 18:1:1, about 387:40:3, about 20:1:1, or about 430:40:3, and ratios within these bounds.

In some preferred embodiments where the pre-concentrated floc shortening is filtered to remove free oil, the concentrated floc shortening contains oil, powder, and polyol in proportions set forth e.g., in Table 1, wherein the concentration of oil is between about 40% and 60% w/w. In one embodiment, the ratio by weight of oil to powder to polyol (oil:powder:polyol) of the concentrated floc shortening is about 1-25 parts oil to about 1-15 parts powder to about 1 part polyol. In one embodiment, the oil:powder:polyol ratio of the concentrated floc shortening is about 4:1:1, about 25:13:1, about 1:1:1, about 9:15:1, about 10:3:3, about 69:40:3, about 7:3:3, about 47:40:3, about 4:3:3, about or 26:40:3, and ratios within these bounds.

In certain embodiments, the floc shortening systems provided herein further comprise one or more additives. Common additives that can be added to the shortening floc shortening systems provided herein include, but are not limited to stabilizers, flavoring agents, emulsifiers, anti-spattering agents, colorants, or antioxidants. Exemplary additives are described, for example, in Campbell et al., Food Fats and Oils, 8th Ed., Institute of Shortening and Edible Oils, Washington, D.C.

In certain embodiments, the floc shortening systems further comprise a preservative or an antioxidant. A wide variety of preservatives and antioxidants are suitable for use, including but not limited to butylated hydroxytoluene (BHT), butylated hydroxyanisole (BHA), tertiary butylhydroquinone (TBHQ), ethylenediaminetetracetic acid (EDTA), potassium sorbate, gallate esters (i.e., propyl gallate, butyl gallate, octyl gallate, dodecyl gallate, etc.), tocopherols, lactic acid, citric acid, citric acid esters (i.e., isopropyl citrate, etc.), gum guaiac, nordihydroguaiaretic acid (NDGA), thiodipropionic acid, ascorbic acid, ascorbic acid esters (i.e., ascorbyl palmitate, ascorbyl oleate, ascorbyl stearate, etc.) tartaric acid, lecithin, methyl silicone, sodium benzoate, polymeric antioxidant (Anoxomer) plant (or spice and herb) extracts (i.e., rosemary, sage, oregano, thyme, marjoram, etc.) and mixtures thereof. In certain embodiments, preservatives and antioxidants include but not limited to butylated hydroxytoluene (BHT), butylated hydroxyanisole (BHA), tertiary butylhydroquinone (TBHQ), ethylenediaminetetracetic acid (EDTA), gallate esters (i.e., propyl gallate, butyl gallate, octyl gallate, dodecyl gallate, etc.), tocopherols, lactic acid, citric acid, citric acid esters (i.e., isopropyl citrate, etc.), gum guaiac, nordihydroguaiaretic acid (NDGA), thiodipropionic acid, ascorbic acid, ascorbic acid esters (i.e., ascorbyl palmitate, ascorbyl oleate, ascorbyl stearate, etc.) tartaric acid, lecithin, methyl silicone, sodium benzoate, polymeric antioxidant (Anoxomer) plant (or spice and herb) extracts (i.e., rosemary, sage, oregano, thyme, marjoram, etc.) and mixtures thereof.

In certain embodiments, the floc shortening systems further comprise an emulsifier in addition to the subject polyol. A wide variety of emulsifiers are suitable for use, including but not limited to mono- and diglycerides, distilled monoglycerides, polyglycerol esters of C12 to C22 fatty acids, propylene glycol mono and diesters of C12 to C22 fatty acids, sucrose mono- and diesters of C14 to C22 fatty acids.

In certain embodiments, the floc shortening systems further comprise an anti-molding agent, such as potassium sorbate. In certain embodiments, the anti-molding agent in the floc shortening systems is from about 0.05% to about 0.2% based on total weight of the floc shortening system. In certain embodiments, the anti-molding agent in the floc shortening systems is from about 0.05% to about 0.15% based on total weight of the floc shortening system. In certain embodiments, the anti-molding agent in the floc shortening systems is about 0.05%, 0.75%, 0.1%, 0.15% or 0.2% based on total weight of the floc shortening system.

In certain embodiments, the floc shortening systems further comprise additional ingredients, such as salt, coloring and flavoring agents. In certain embodiments the flavoring agents include butter flavoring agents, meat flavoring agents, tallow flavoring agents, olive oil flavoring agents and other natural or synthetic flavoring agents. In certain embodiments, vitamins can be included in the floc shortening systems provided herein. In certain embodiments, various other additives can be used in the floc shortening systems provided that they are edible and aesthetically desirable.

### Cooked Products Containing the Floc Shortening System

A further aspect of the invention includes cooked products containing the subject floc shortening system and other ingredients. In some embodiments, the cooked products can comprise baked foods such as cookies, crackers, biscuits, cakes, pie crusts, donuts, muffins, rolls, biscuits, and pastries. In other embodiments, the cooked product can include other foods such as fillings or popcorn. These cooked products can be prepared for consumption by humans or animals.

In one embodiment, the floc shortening system is used to replace conventional shortening, i.e., a “replacement shortening” for e.g., lard, butter, hydrogenated vegetable shortening, oil, and the like, in baking and in baked goods and other foods. In one embodiment, the subject floc shortening system replaces conventional shortening at a weight-to-weight ratio of about 0.5:1 to about 2:1. In some embodiments, the amount of floc shortening is adjusted to account to the amount of flour, sugar, and other carbohydrates or proteins in the recipe or in the final baked goods. In one embodiment, the subject floc shortening replaces conventional shortening at a weight-to-weight ratio of about 0.5:1, about 0.6:1, about 0.7:1, about 0.8:1, about 0.9:1, about 1:1, about 1.1:1, about 1.2:1, about 1.3:1, about 1.4:1, about 1.5:1, about 1.6:1, about 1.7:1, about 1.8:1, about 1.9:1, or about 2:1 floc shortening:conventional shortening.

### EMBODIMENTS

In a first embodiment, a shortening system comprising an oil, a polyol and a plurality of edible finely divided particles is provided.

In a second embodiment, a shortening system of the first embodiment is provided wherein the polyol and edible finely divided particles form a floc.

In a third embodiment, a shortening system of the first or second embodiment is provided wherein the edible finely divided particle is selected from the group consisting of starch granules, salt, powdered sugar, and rice flour.

In a fourth embodiment, a shortening system of any one of the first through the third embodiments is provided wherein the starch granules include natural or chemically modified starches.

In a fifth embodiment, a shortening system of any one of the first through the fourth embodiments is provided wherein the starch granules comprise corn starch.

In a sixth embodiment, a shortening system of any one of the first through fifth embodiments is provided wherein the oil is a vegetable oil.

In a seventh embodiment, a shortening system of any one of the first through sixth embodiments is provided wherein the oil comprises a mixture of canola oil, fully hydrogenated palm oil, and fully hydrogenated soybean oil.

In an eighth embodiment, a shortening system of any one of the first through seventh embodiments is provided wherein the ratio by weight of edible finely divided particles to polyol is about 1:0.65 to 1:0.15.

In a ninth embodiment, a shortening system of any one of the first through eighth embodiments is provided wherein the edible finely divided particle comprises corn starch, the polyol comprises glycerol, and the ratio by weight of corn starch to glycerol is about 1:0.65 to 1:0.15.

In a tenth embodiment, a shortening system of any one of the first through ninth embodiments is provided wherein the ratio by weight of corn starch to glycerol is about 1:0.45 to 1:0.3.

In an eleventh embodiment, a shortening system of any one of the first through tenth embodiments is provided wherein the ratio by weight of oil to edible finely divided particles to polyol is about 1-150 parts oil to about 1-15 parts edible finely divided particles to about 1 part polyol.

In a twelfth embodiment, a shortening system of any one of the first through eleventh embodiments is provided wherein the percent weight of oil, percent weight of finely divided particles, and percent weight of polyol are selected from the group of admixtures set forth in Table 1.

In a thirteenth embodiment, a shortening system is provided that comprises (a) an oil that comprises about 75-95% canola oil, about 1-20% fully hydrogenated palm oil, and about 1-10% fully hydrogenated soybean oil; (b) about 1-20% starch; and (c) about 1-10% glycerol by weight based on the total weight of the shortening system.

In a fourteenth embodiment, a shortening system is provided that comprises (a) an oil that comprises about 85% canola oil, 10% fully hydrogenated palm oil, and 4% fully hydrogenated soybean oil, (b) about 10% starch, and (c) about 3% glycerol by weight based on the total weight of the shortening system.

In a fifteenth embodiment, a shortening system of the thirteenth or the fourteenth embodiment is provided wherein the total amount of oil is about 40% to about 60% by weight based on the total weight of the shortening system.

In a sixteenth embodiment, a shortening system of the thirteenth or the fourteenth embodiment is provided wherein the total amount of oil is greater than 60% by weight based on the total weight of the shortening system.

In a seventeenth embodiment, a shortening system of any one of the first through sixteenth embodiments that further comprises a salt is provided.

In an eighteenth embodiment, a food product comprising the shortening system of any one of the first through seventeenth embodiments is provided.

In a nineteenth embodiment, a food product of the eighteenth embodiment is provided wherein the food product is selected from the group consisting of microwave popcorn, cake, cookie, pie crust and biscuit.

In a twentieth embodiment, a method of preparing a shortening system of any one of the first through seventeenth embodiments is provided, the method comprising (a) mixing an oil and a polyol; (b) adding a plurality of edible finely divided particles, wherein a floc forms; and (c) solidifying the shortening system.

In a twenty-first embodiment, a method according to the twentieth embodiment for preparing the shortening system is provided wherein the shortening system is heated during the mixing step (a) and the adding step (b) to a temperature of about 50-70° C.

In a twenty-second embodiment, a method according to the twentieth or twenty-first embodiment for preparing the shortening system is provided wherein the shortening system is heated during the mixing step and the adding step to a temperature of about 60° C.

In a twenty-third embodiment, a method according to any one of the twentieth through twenty-second embodiments for preparing the shortening system is provided wherein the shortening system is solidified at step (c) by cooling the shortening system in a scraped surface heat exchanger.

In a twenty-fourth embodiment, a method according to any one of the twentieth through twenty-third embodiments for preparing the shortening system is provided further comprising the step of removing free oil from the shortening system after step (b) and before solidifying the shortening at step (c).

In a twenty-fifth embodiment, a method according to the twenty-fourth embodiment for preparing the shortening system is provided wherein the free oil is removed by filtering the shortening system with qualitative filter paper.

### Example 1

### Preparation of the Floc Shortening Systems

The floc shortening system of the present invention can be prepared by any suitable method known in the art. Several 1,000 gram batches of the floc shortening system were prepared. The following oils were combined in a 2,000 ml jacketed beaker with the jacket water controlled at 60° C.: 85.340% canola oil, 10.262% fully hydrogenated palm oil, and 4.398% fully hydrogenated soybean oil. Glycerol (0.3% of glycerol for each 1% of starch) was added to the oil combination. The mixture was sheared using a SILVERSON L5MA mixer (East Longmeadow, Mass.) with the square hole high shear screen, operated at 5000 rpm for 2 to 2½ minutes. The corn starch (4%, 7% and 10%) was then added with the mixer running for an additional 2 to 2½ minutes to form an aggregated mass of starch particles (i.e., “floc” or “flocculi”). The shortening system containing 10% starch was replicated.

Following formation of the floc, the mixture was poured into and cooled in a CUISINART Ice Cream maker (East Windsor, NJ), where crystals were allowed to form. The crystallized mixture attained enough solidity that removing the dasher from the machine pulled out almost all of the mixture. The resultant floc shortening system was stored in an airtight, waterproof bag and stored at room temperature (e.g., 70° F.) until it was further evaluated.

A skilled artisan would appreciate that a wide range of mixing conditions can produce a shortening system. In other embodiments, the ingredients can be added in a different order. For example, the starch, or other finely divided particles, can be added to the oil combination before the addition of the glycerol or other polyol. In other embodiments, the crystallization can occur over a range of bulk shortening temperatures, including room temperature, or at temperatures ranging from 10−40° C., or at lower temperatures.

### Example 2

### Floc Shortening Systems in Food Products

Another floc shortening system was prepared using canola oil, a solid fat DAG, corn starch, glycerin, and tert-butylhydroquinone (TBHQ) as an antioxidant preservative (Table 2). This floc system was crystallized in a scraped surface heat exchanger, and further evaluated in the preparation of food products.

TABLE 2
Composition of an Embodiment of a Floc Shortening System

| Ingredient | % w/w | Weight (pounds) | Mass (grams) |
|---|---|---|---|
| Canola oil | 68.2241 | 81.869 | 37135.12 |
| DAG | 18.6932 | 22.432 | 10174.91 |
| Corn starch | 10.0000 | 12.000 | 5443.11 |
| Glycerol | 3.0000 | 3.600 | 1632.93 |
| TBHQ | 0.0827 | 0.099 | 45.01 |

### Example 3

Food Products with Floc Shortening Systems

The floc shortening system described in Example 2 was evaluated against ULTRABLENDS® 148 all-purpose shortening (“UB148”) (Bunge, St. Louis, Mo.), a shortening composition that contains cellulose fibers. Sugar cookies were prepared according to the same recipe (Table 3), using either the UB148 or the floc shortening system described in Example 2 (“CS-F1”). The resulting sugar cookies were assessed for various qualities including appearance, durability, size, degree of spreading, color, taste, and texture.

The sugar cookies made with the floc shortening system spread slightly more than the sugar cookies made with the UB148 shortening, but the amount of spreading was well within acceptable limits. Similar results were also obtained with sugar cookies made with ULTRABLENDS® 172 all-purpose shortening (not shown).

TABLE 3
Evaluation of Sugar Cookies Made with Floc Shortening System.

Formulation

| Test parameter | UB148 | CS-F1 |
|---|---|---|
| Dough appearance (wet to dry | 4 | 4 |
| on scale of 1 to 5) | | |
| Ease of handling | Firm | Firm |
| Stacked height (cm) | 6.6 | 5.9 |
| Length (cm) | 39.8 | 42 |
| Width (cm) | 40.3 | 41.9 |
| Weight (g) | 170 | 173 |
| Cookie color (dark to light on a | 4 | 4 |
| scale of 1 to 5) | | |
| Taste (objectionable to | 4 | 4 |
| acceptable on a scale of 1 to 5) | | |
| Texture (crisp to soft on a scale | 3 | 3 |
| of 1 to 5) | | |
| Shortness of bite (short to chewy | 3 | 3 |
| on a scale of 1 to 5) | | |
| Overall appearance | Translucent, | Soft |
| | short, soft | |

### Example 4

### Optimal Ratios of Corn Starch and Glycerol for Floc Formation

Not every combination of corn starch and glycerol was observed to generate a floc structure, so floc shortening systems were made with varying ratios of corn starch to glycerol, to identify the range of corn starch:glycerol ratios that would produce shortening systems with a floc structure.

TABLE 4
Powder to Polyol Ratios

| Ratio of | |
|---|---|
| corn starch:glycerol | Amount of floc formation |
| 1 to 1 | No floc formed. |
| 1 to 0.65 | A coarse floc formed and rapidly settled. |
| 1 to 0.45 | A large floc formed. |
| 1 to 0.3 | A large floc formed; larger than the floc observed |
| | for the 1 to 0.45 ratio of corn starch:glycerol. |
| 1 to 0.15 | A fine floc formed. |
| 1 to 0.075 | Minimal floc formed. |

The ratios of corn starch:glycerol were varied between 1:1 to 1:0.075, and the floc was prepared at 60° C. In this example, a 1:1 ratio failed to produce a floc structure. After the corn starch was covered by glycerol, enough uncomplexed glycerol was left such that the particles were dispersed in glycerol. A coarse floc formed when the ratio was increased to 1:0.65. This floc settled rapidly, making it a usable but maybe not optimal for some applications.

Flocs of varying size were produce with powder:polyol ratios ranging 1:0.65 to 1:0.15. The largest floc formation was observed with the 1:0.3 ratio. Similar flocs were obtained when the corn starch was substituted with fine salt, powdered sugar, or rice flour at the 1:0.3. At 1 to 0.075, any floc that formed under these particular conditions was minimal.

### Example 5

### Ratios of Corn Starch and Glycerol in Oil

To further determine the upper limits to which a polyol and finely divided particles combination can be loaded with oil, certain combinations of glycerol, corn starch, and oil were prepared. A combination of 200 grams of starch, 60 grams of glycerol, and 740 grams of oil were prepared; after preparation, the oil still flowed readily upon pouring. In comparison, when 300 grams of starch, 90 grams of glycerol, and 610 grams of oil were combined, the oil still poured although the consistency of the mixture was thicker.

### Example 6

### Method of Making a Floc Shortening System

A further aspect of the present invention is related to a process for making the floc shortening system, including the steps of mixing finely divided particles with a polyol to obtain a flocculent mixture; further adding an oil to the flocculent mixture; and solidifying the flocculent mixture.

The mixing and adding steps can be done at any temperature suitable for processing, including room temperature. Preferably, each step is done at a temperature of about 50-70° C., or more preferably at a temperature of about 60° C. In some embodiments, both steps are performed at substantially the same temperature.

The solidifying step can be accomplished by any suitable method known in the art. Such methods include cooling at room temperature, cooling in an ice cream maker, cooling in an ice bath or water bath, or by refrigeration or freezing. In some embodiments, crystallization can be promoted by additional methods, such as agitation. For example, in an industrial setting, a scrapped surface heat exchanger may commonly be used to conduct or drive the crystallization.

### Example 7

### Microwave Popping Corn Product Containing a Floc Shortening System

A further aspect of the invention includes a food product containing the floc shortening system of the present invention containing salt, plus other ingredients which can include popcorn.

### Example 8

### Concentration of Corn Starch-Containing Floc

To produce a concentrated floc material, free oil was removed from floc suspensions by filtration. Sufficient care was taken in the removal of free oil to form a soft solid floc shortening mass without pulling off so much oil that the starch and glycerol become too exposed to water or other hydrous materials such as eggs when mixing the dough or batter.

900 grams of a floc was formed by combining 740 grams of oil (canola oil 658.6 g, fully hydrogenated palm oil 57 g, 24.4 g fully hydrogenated soybean oil), 200 grams of corn starch, and 60 grams of glycerin at about 60° C. using the SILVERSON L5MA mixer with some additional hand stirring to help feed the starch into the mixing head. 900 grams of floc was vacuum filtered on a 15 cm Buchner funnel using WHATMAN® qualitative filter paper, Grade 4, and the resultant filtrate (“cake”) was weighed. Enough oil was pulled from the floc to create a cake with uniform consistency that did not separate upon standing.

When the 900 gram floc was filtered to a cake weight of about 375 grams or less, which represents a reduction in mass of about 58% or more, the resulting material was observed not to have enough oil to function well as a shortening.

When the 900 gram floc was filtered to a cake weight of about 408 grams, which represents a reduction in mass of about 55%, no oil was observed to separate from the filtrate.

When the 900 gram floc was filtered to a cake weight of about 434 grams, which represents a reduction in mass of about 52%, the filtrate contained some free oil, which was readily stirred back into the mass (i.e., composited). The 52% mass reduction (48% of the mass remaining as a cake) was observed to produce the upper end of oiliness for a uniform product. The 48% mass was analyzed for total oil and specific fatty acid content, as described below.

Five floc batches of were filtered and composited. Each filtered and composited floc batch was analyzed using the gas-liquid chromatography method of the American Oil Chemists' Society (AOCS) official method Celh-05 (2017 revision available at https://www.aocs.org/attain-lab-services/methods/methods/method-detail?product_Id=111777, or from AOCS, 2710 S. Boulder, Urbana, Ill. 61802 US) to determine the oil content, which was reported at about 49.83% (w/w) (average of N=2). The fatty acid content of the filtered and composited corn starch-based floc mass was determined by fatty acid methyl ester gas chromatography analysis. The results of two corn starch-based concentrated floc samples (#1 and #2) are presented in Table 5.

TABLE 5
Fatty Acid Species Content

| | |
|---|---|
| Fatty | |
| Acid | Sample |

| Species | #1 | #2 |
|---|---|---|
| C4 | — | — |
| C6 | — | — |
| C8 | — | — |
| C10 | — | — |
| C11 | — | — |
| C12 | — | — |
| C13 | — | — |
| C14 | 0.07 | 0.07 |
| C14:1 | — | — |
| C15 | — | — |
| ISO C16 | — | — |
| C15:1 | 0.01 | — |
| C16 | 4.15 | 4.02 |
| C16:1T | 0.02 | — |
| C16:1 | 0.13 | 0.13 |
| C17 | — | — |
| C17:1 | 0.05 | 0.05 |
| C18 | 3.64 | 3.49 |
| C18:1T | 0.05 | 0.05 |
| C18:1 | 26.82 | 25.80 |
| C18:2T | 0.07 | 0.06 |
| C18:2 | 8.42 | 8.21 |
| C20 | 0.31 | 0.28 |
| C18:3T | 0.01 | 0.13 |
| C20:1 | 0.73 | 0.56 |
| C18:3 | 3.76 | 3.68 |
| C18:2 conj | — | — |
| C20:2 | 0.03 | — |
| C22 | 0.17 | 0.16 |
| C20:3 | — | — |
| C22:1 | — | — |
| C20:4 | — | — |
| C23 | — | — |
| C20:5 | — | — |
| C24 | 0.06 | 0.05 |
| C24:1 | 0.06 | 0.05 |
| Total | 50.74 | 48.91 |
| Sat'd FA | 8.39 | 8.07 |
| PUFA | 12.20 | 11.89 |
| Trans | 0.14 | 0.23 |
| Mono | 27.80 | 26.59 |

The filtered and composited material was left at room temperature (e.g., about 21° C.) over night before initial application testing. The solids in the oil system crystalized (a.k.a. solidified) overnight at room temperature without the use of a scraped surface heat exchanger.

### Example 9

### Concentration of White Millet-Containing Floc

A floc system was made with 200 grams of whole grain white millet flour, 60 grams glycerol, and 740 grams of oil (636.4 grams canola oil, 72.5 g fully hydrogenated palm oil, 31.1 g full hydrogenated soybean oil) at 60° C. 900-gram batches of the material were filtered at a time as described for the corn starch samples in Example 8. Four batches were composited to make the material used in application testing. The AOCS Celh-05 analysis of the concentrated floc showed an oil content of 38.37% w/w (average of N=2).

The fatty acid content of the filtered and composited white millet flour-based floc mass was determined by fatty acid methyl ester gas chromatography analysis. The results of two white millet flour-based concentrated floc samples (#3 and #4) are presented in Table 6.

TABLE 6
Fatty Acid Species Content (% w/w)

| | |
|---|---|
| Fatty Acid | Sample |

| Species | #3 | #4 |
|---|---|---|
| C4 | — | — |
| C6 | — | — |
| C8 | — | — |
| C10 | — | — |
| C11 | — | — |
| C12 | — | — |
| C13 | — | — |
| C14 | 0.07 | 0.07 |
| C14:1 | — | — |
| C15 | — | — |
| ISO C16 | — | — |
| C15:1 | — | — |
| C16 | 3.98 | 4.07 |
| C16:1T | — | 0.01 |
| C16:1 | 0.09 | 0.10 |
| C17 | — | — |
| C17:1 | 0.03 | 0.04 |
| C18 | 3.75 | 3.87 |
| C18:1T | 0.03 | 0.04 |
| C18:1 | 18.73 | 19.01 |
| C18:2T | 0.04 | 0.03 |
| C18:2 | 6.12 | 6.29 |
| C20 | 0.23 | 0.24 |
| C18:3T | 0.10 | 0.14 |
| C20:1 | 0.40 | 0.42 |
| C18:3 | 2.50 | 2.60 |
| C18:2 conj | — | — |
| C20:2 | 0.02 | 0.02 |
| C22 | 0.13 | 0.13 |
| C20:3 | — | — |
| C22:1 | — | — |
| C20:4 | — | — |
| C23 | — | — |
| C20:5 | — | — |
| C24 | 0.04 | 0.04 |
| C24:1 | 0.04 | — |
| Total | 37.94 | 38.80 |
| Sat'd FA | 8.19 | 8.42 |
| PUFA | 8.64 | 8.91 |
| Trans | 0.17 | 0.22 |
| Mono | 19.30 | 19.56 |

The filtered and composited material was left at room temperature (e.g., about 21° C.) overnight as was done with the concentrated corn starch-based floc system, and the solid fat crystallized to provide additional structure to the mass.

### Example 10

### Crystallization of Filtered and Composited Floc

For commercial production, the concentrated floc is fed to a scraped surface heat exchanger or sent down a cooling tunnel before packaging. Alternatively, the concentrated floc is packaged without pre-cooling. When the concentrated floc is not cooled, it is stored in a warehouse at a temperature below the melting point of the oil phase to enable the crystallization of the solids.

### Example 11

### Application of Filtered and Composited Floc

The filtered and composited floc batches were tested in a baked-goods application. The following chocolate cookie recipe (Table 7) was used to evaluate the two experimental concentrated floc systems (corn starch-based [samples #1 and #2] and millet flour-based [samples #3 and #4] of tables 5 and 6), with the floc shortening system used as a one-to-one (1:1) replacement for the shortening called for in the recipe.

TABLE 7
Chocolate Chip Cookie Recipe - Mixed in 12-quart Bowl

| | | | |
|---|---|---|---|
| | | Actual % (based | |
| | | on total weight of | Baker's % (based |
| Ingredient/Step | Amount (g) | formula) | on weight of flour) |

STAGE 1:

| | | | |
|---|---|---|---|
| Granulated Sugar | 368.5 | 17.04% | 53.87% |
| Brown Sugar | 368.5 | 17.04% | 53.87% |
| Salt | 17.7 | 0.82% | 2.59% |
| Baking Soda | 7.1 | 0.33% | 1.04% |
| Shortening | 482 | 22.29% | 70.46% |

Cream for 3 minutes on first setting.

STAGE 2:

| | | | |
|---|---|---|---|
| Whole Eggs | 227 | 10.50% | 33.18% |
| Vanilla | 7.1 | 0.33% | 1.04% |

Cream for 2 minutes on first setting.

STAGE 3:

| | | | |
|---|---|---|---|
| Pastry Flour | 680.5 | 31.48% | 99.47% |
| Cream of Tartar | 3.6 | 0.17% | 0.53% |

Smooth for 2 minutes on first setting.

STAGE 4:

| | | | |
|---|---|---|---|
| Chocolate Chips | 453.5 | 20.98% | 66.29% |
| Total | 2162 | 100.00% | 316.04% |

Mix to fold in chocolate chips (15 seconds on first setting).
Deposit 39 g of dough onto cookie sheet using an ice cream scoop.
Bake at 370° F.-380° F. for approximately 12 minutes.

Test doughs and cookies were manufactured with millet flour-based concentrated floc (“MF-F”), corn starch-based concentrated floc (“CS-F”), or the control shortening containing palm oil and high oleic canola oil (BUNGE NH Technology 208 cookie shortening, Bunge North America, St. Louis, Mo.) (“NH208”) as the shortening component according to the recipe of Table 7. The attributes of each test dough or test cookie product are depicted in Table 8.

TABLE 8
Dough and Cookie Attributes

| | Shortening | | |
|---|---|---|---|
| Test parameter | NH208 | CS-F | MF-F |
| Dough appearance (wet to dry | 3 | 4 | 5 |
| on scale of 1 to 5) | | | |
| Ease of handling | easy | much more firm | much more |
| | | | firm |
| Stacked height (cm) | 4.8 | 7 | 8.7 |
| Length (cm) | 48.4 | 38.9 | 35.6 |
| Width (cm) | 48.3 | 40.4 | 35.2 |
| Weight (g) | 173.5 | 211.8 | 213.0 |
| Cookie color (dark to light on | 2.5 | 3.5 | 3 |
| a scale of 1 to 5) | | | |
| Taste (objectionable to | 5 | 5 | 5 |
| acceptable on a scale of 1 to | | | |
| 5) | | | |
| Texture (crisp to soft on a | 3.5 | 4.5 | 5 |
| scale of 1 to 5) | | | |
| Shortness of bite (short to | 4 | 4.5 | 5 |
| chewy on a scale of 1 to 5) | | | |
| Overall appearance | normal | less spread | even less |
| | | | spread |

The two test formulations (CS-F and MF-F) both produced much firmer doughs and required additional mixing or hand working to fold in the chocolate chips. The control (NH208) cookies showed the most spread upon baking. During the creaming step of Stage 1, the CS-F dough was grainy in appearance, and the MF-F dough was sandy in appearance. After the addition of eggs and vanilla at Stage 2, the MF-F dough resembled the control with decreased volume, whereas the CS-F dough appeared as if the emulsion would break, which it did not. Both CS-F and MF-F needed more moisture. Upon adding flour at Stage 3, both CS-F and MF-F doughs became very firm. Both CS-F and MF-F doughs would not take the chocolate chips and required pushing the chips into the dough by hand.

Following this result, the baker adjusted the formulation for the millet floc by reducing the amount of flour by 221.7 grams to account for the millet flour coming in with the concentrated floc shortening (“Reduced Flour MF-F”). The test formulation with reduced flour content was also run with all the sugar being granulated instead of the one to one blend of granulated and brown sugar called for in the original recipe (“All Granulated”). Both formulation adjustments produced cookies that had a spread that was closer to control. The cookies were not as uniformly round as the length and width measurements show. Both formulations resulted in doughs that appeared and behaved similarly to the palm-based control (NH208) samples. The results are depicted in Table 9.

TABLE 9
Dough and Cookie Attributes - Reduced Fluor Formulation

| | Formulation | |
|---|---|---|
| | Reduced Flour | |
| Test parameter | MF-F | All Granulated |
| Dough appearance (wet to dry | 3 | 3 |
| on scale of 1 to 5) | | |
| Ease of handling | Resembles control | Resembles control |
| Stacked height (cm) | 5.1 | 6.4 |
| Length (cm) | 43.5 | 43.5 |
| Width (cm) | 46.2 | 47 |
| Weight (g) | 192.1 | 184.3 |
| Cookie color (dark to light on | 3.5 | 4.5 |
| a scale of 1 to 5) | | |
| Taste (objectionable to | 5 | 4.5 |
| acceptable on a scale of 1 to | | |
| 5) | | |
| Texture (crisp to soft on a | 4 | 2 |
| scale of 1 to 5) | | |
| Shortness of bite (short to | 3 | 3 |
| chewy on a scale of 1 to 5) | | |
| Overall appearance | good | Pale but acceptable; |
| | | crisp exterior |

Another test dough comparison was run with a formulation containing the corn starch based concentrated floc with the same level of flour reduction (about 46% reduction in fluor) that had been used with the whole grain white millet flour floc (“Reduced Flour CS-F). Here, the control shortening was the palm oil-based Bunge NH 100 (BUNGE NH Technology 100 all-purpose shortening, Bunge North America, St. Louis, Mo.) (“NH100”). The resulting cookies were similar in size to the control-containing cookies, but not as uniformly round as the length and width measurements show.

TABLE 10
Dough and Cookie Attributes - Reduced Flour Formulation

Formulation

| | | Reduced flour |
|---|---|---|
| Test parameter | NH100 | CS-F |
| Dough appearance (wet to dry | 3 | 3 |
| on scale of 1 to 5) | | |
| Ease of handling | Good/ | Resembles |
| | easy | control |
| Stacked height (cm) | 5 | 5 |
| Length (cm) | 48.5 | 47.9 |
| Width (cm) | 47.6 | 49 |
| Weight (g) | 175.7 | 193.8.3 |
| Cookie color (dark to light on | 3 | 3.5 |
| a scale of 1 to 5) | | |
| Taste (objectionable to | 4.5 | 5 |
| acceptable on a scale of 1 to | | |
| 5) | | |
| Texture (crisp to soft on a | 3 | 4 |
| scale of 1 to 5) | | |
| Shortness of bite (short to | 3 | 4 |
| chewy on a scale of 1 to 5) | | |
| Overall appearance | okay | irregular shape |

The reduced flour corn starch floc-based recipe had a sandy appearance at the Stage 1 creaming step. After adding egg and vanilla at Stage 2, the reduced flour CS-F dough attained a nice fluffy appearance similar to the NH208 control formulation, but appeared to be close to breaking emulsion. The dough did not break emulsion. At Stages 3 and 4, the flour mixed in easily, and the chocolate chips mixed in well. The chips had an oily appearance in the dough, but were more prominent in the finished cookie.

Both the corn starch based system (CS-F) and the whole grain white millet flour based system (MF-F) had saturated fatty acid levels of less than 9%, which is lower than the plastic shortenings found on the market today. Each of the two control shortenings used in this evaluation, NH208 and NH100, had a saturated fatty acid level of 23% and 35%, respectively.

What is claimed is:

1. A shortening system comprising an oil, a polyol and a plurality of edible finely divided particles.

2. The shortening system of claim 1, wherein the polyol and edible finely divided particles form a floc.

3. The shortening system of claim 2, wherein the edible finely divided particle is selected from the group consisting of starch granules, salt, powdered sugar, and rice flour.

4. The shortening system of claim 3, wherein the starch granules include natural or chemically modified starches.

5. The shortening system of claim 3, wherein the starch granules comprise corn starch.

6. The shortening system of claim 2, wherein the oil is a vegetable oil.

7. The shortening system of claim 2, wherein the oil comprises a mixture of canola oil, fully hydrogenated palm oil, and fully hydrogenated soybean oil.

8. The shortening system of claim 2, wherein the ratio of edible finely divided particles to polyol is about 1:0.65 to 1:0.15.

9. The shortening system of claim 2, wherein the edible finely divided particle comprises corn starch, the polyol comprises glycerol, and the ratio of corn starch to glycerol is about 1:0.65 to 1:0.15.

10. The shortening system of claim 9, wherein the ratio of corn starch to glycerol is about 1:0.45 to 1:0.3.

11. The shortening system of claim 2, wherein the ratio by weight of oil to edible finely divided particles to polyol is about 1-150 parts oil to about 1-15 parts edible finely divided particles to about 1 part polyol.

12. The shortening system of claim 11, wherein the percent weight of oil, percent weight of finely divided particles, and percent weight of polyol are selected from the group of admixtures set forth in Table 1.

13. A shortening system comprising:
(a) an oil comprising about 75-95% canola oil, about 1-20% fully hydrogenated palm oil, and about 1-10% fully hydrogenated soybean oil;
(b) about 1-20% starch; and
(c) about 1-10% glycerol by weight based on the total weight of the shortening system.

14. A shortening system comprising:
(a) an oil comprising about 85% canola oil, 10% fully hydrogenated palm oil, and 4% fully hydrogenated soybean oil;
(b) about 10% starch; and
(c) about 3% glycerol by weight based on the total weight of the shortening system.

15. The shortening system of claim 13, wherein the total amount of oil is about 40% to about 60% by weight based on the total weight of the shortening system.

16. The shortening system of claim 13, wherein the total amount of oil is greater than 60% by weight based on the total weight of the shortening system.

17. The shortening system of claim 13 further comprising salt.

18. A food product comprising the shortening system of claim 17.

19. The food product of claim 18 selected from the group consisting of microwave popcorn, cake, cookie, pie crust and biscuit.

20. A method of preparing the shortening system comprising:
(a) mixing an oil and a polyol;
(b) adding a plurality of edible finely divided particles, wherein a floc forms; and
(c) solidifying the shortening system.

21. The method of claim 20, wherein the shortening system is heated during the mixing step (a) and the adding step (b) to a temperature of about 50-70° C.

22. The method of claim 20, wherein the shortening system is heated during the mixing step and the adding step to a temperature of about 60° C.

23. The method of claim 20, wherein the shortening system is solidified at step (c) by cooling the shortening system in a scraped surface heat exchanger.

24. The method of claim 23 further comprising the step of removing free oil from the shortening system after step (b) and before solidifying the shortening at step (c).

25. The method of claim 24, wherein the free oil is removed by filtering the shortening system.

26. The method of claim 24, wherein the free oil is removed by centrifugation of the shortening system.
